(19) United States
(12) Patent Application Publication
(10) Pub. No.: US 2020/0014901 A1
(43) Pub. Date: Jan. 9, 2020

(54) INFORMATION PROCESSING APPARATUS, CONTROL METHOD THEREFOR AND COMPUTER-READABLE MEDIUM

(71) Applicant: CANON KABUSHIKI KAISHA, Tokyo (JP)

(72) Inventor: Naoki Umemura, Abiko-shi (JP)

(21) Appl. No.: 16/454,626

(22) Filed: Jun. 27, 2019

(30) Foreign Application Priority Data
Jul. 4, 2018 (JP) 2018-127794

(51) Int. Cl. H04N 13/117; H04N 13/167; G06T 7/70; G06T 7/20; H04N 13/383

(52) U.S. Cl. CPC H04N 13/117; H04N 13/167; H04N 13/383; G06T 7/20; G06T 7/70

(57) ABSTRACT

An information processing apparatus comprises a setting unit that sets a first virtual viewpoint regarding generation of a virtual viewpoint image based on multi-viewpoint images obtained from a plurality of cameras, and a generation unit that generates, based on the first virtual viewpoint set by the setting unit, viewpoint information representing a second virtual viewpoint that is different in at least one of a position and direction from the first virtual viewpoint set by the setting unit and corresponds to a timing common to the first virtual viewpoint.

### BACKGROUND OF THE INVENTION

### Field of the Invention

The present invention relates to an information processing apparatus regarding generation of a virtual viewpoint image, a control method therefor and a computer-readable medium.

### Description of the Related Art

These days, attention has been paid to a technique of generating a virtual viewpoint image using a plurality of viewpoint images obtained by installing a plurality of cameras at different positions and executing synchronous shooting from multiple viewpoints. The technique of generating a virtual viewpoint image allows a user to, for example, view highlights of soccer or basketball from various angles and can give a high realistic sensation to him/her.

A virtual viewpoint image based on a plurality of viewpoint images is generated by collecting images captured by a plurality of cameras to an image processing unit such as a server and performing processes such as three-dimensional model generation and rendering by the image processing unit. The generation of a virtual viewpoint image requires setting of a virtual viewpoint. For example, a content creator generates a virtual viewpoint image by moving the position of a virtual viewpoint over time. Even for an image at a single timing, various virtual viewpoints can be necessary depending on viewer tastes and preference. In Japanese Patent Laid-Open No. 2015-187797, a plurality of viewpoint images and free viewpoint image data including metadata representing a recommended virtual viewpoint are generated. The user can easily set various virtual viewpoints using the metadata included in the free viewpoint image data.

When virtual viewpoint images are provided to a plurality of viewers of different tastes or when a viewer wants to view both a virtual viewpoint image at a given viewpoint and a virtual viewpoint image at another viewpoint, a plurality of virtual viewpoint images corresponding to a plurality of virtual viewpoints at the same timing are generated. However, if a plurality of time-series virtual viewpoints are individually set to generate a plurality of virtual viewpoint images, like the conventional technique, setting of virtual viewpoints takes a lot of time. The technique disclosed in Japanese Patent Laid-Open No. 2015-187797 reduces the labor for setting a single virtual viewpoint. However, when a plurality of virtual viewpoints are set, the setting is still troublesome.

### SUMMARY OF THE INVENTION

The present invention provides a technique of enabling easy setting of a plurality of virtual viewpoints regarding generation of a virtual viewpoint image.

According to one aspect of the present invention, there is provided an information processing apparatus comprising: a setting unit configured to set a first virtual viewpoint regarding generation of a virtual viewpoint image based on multi-viewpoint images obtained from a plurality of cameras; and a generation unit configured to generate, based on the first virtual viewpoint set by the setting unit, viewpoint information representing a second virtual viewpoint that is different in at least one of a position and direction from the first virtual viewpoint set by the setting unit and corresponds to a timing common to the first virtual viewpoint.

According to another aspect of the present invention, there is provided an information processing apparatus comprising: a setting unit configured to set a first virtual viewpoint regarding generation of a virtual viewpoint image based on multi-viewpoint images obtained from a plurality of cameras; and a generation unit configured to generate, based on a position of an object included in the multi-viewpoint images, viewpoint information representing a second virtual viewpoint that is different in at least one of a position and direction from the first virtual viewpoint set by the setting unit and corresponds to a timing common to the first virtual viewpoint.

According to another aspect of the present invention, there is provided a method of controlling an information processing apparatus, comprising: setting a first virtual viewpoint regarding generation of a virtual viewpoint image based on multi-viewpoint images obtained from a plurality of cameras; and generating, based on the set first virtual viewpoint, viewpoint information representing a second virtual viewpoint that is different in at least one of a position and direction from the set first virtual viewpoint and corresponds to a timing common to the first virtual viewpoint.

According to another aspect of the present invention, there is provided a method of controlling an information processing apparatus, comprising: setting a first virtual viewpoint regarding generation of a virtual viewpoint image based on multi-viewpoint images obtained from a plurality of cameras; and generating, based on a position of an object included in the multi-viewpoint images, viewpoint information representing a second virtual viewpoint that is different in at least one of a position and direction from the set first virtual viewpoint and corresponds to a timing common to the first virtual viewpoint.

According to another aspect of the present invention, there is provided a non-transitory computer-readable medium storing a program for causing a computer to execute each step of the above-described method of controlling an information processing apparatus.

Further features of the present invention will become apparent from the following description of exemplary embodiments with reference to the attached drawings.

### BRIEF DESCRIPTION OF THE DRAWINGS

FIG. 1 is a block diagram showing an example of the functional configuration of an image generation apparatus according to an embodiment;

FIG. 2 is a schematic view showing an example of the arrangement of virtual viewpoints according to the first embodiment;

FIGS. 3A and 3B are views showing an example of the loci of viewpoints;

FIGS. 4A and 4B are flowcharts showing processing by an another-viewpoint generation unit and a virtual viewpoint image generation unit according to the first embodiment;

FIG. 5 is a schematic view showing an example of the arrangement of viewpoints (virtual cameras) according to the second embodiment;

FIG. 6A is a view three-dimensionally showing the example of the arrangement of viewpoints (virtual cameras);

FIG. 6B is a view showing viewpoint information;

FIG. 7 is a view for explaining a method of arranging viewpoints (virtual cameras) according to the second embodiment;

FIG. 8 is a flowchart showing processing by an another-viewpoint generation unit according to the second embodiment;

FIG. 9 is a view for explaining another example of the arrangement of viewpoints (virtual cameras) according to the second embodiment;

FIGS. 10A and 10B are views showing an example of a virtual viewpoint image from a viewpoint shown in FIG. 9;

FIG. 11A is a view showing a virtual viewpoint image generation system; and

FIG. 11B is a block diagram showing an example of the hardware configuration of the image generation apparatus.

### DESCRIPTION OF THE EMBODIMENTS

Several embodiments of the present invention will now be described with reference to the accompanying drawings. In this specification, an image is a general term of “video” “still image”, and “moving image”.

### First Embodiment

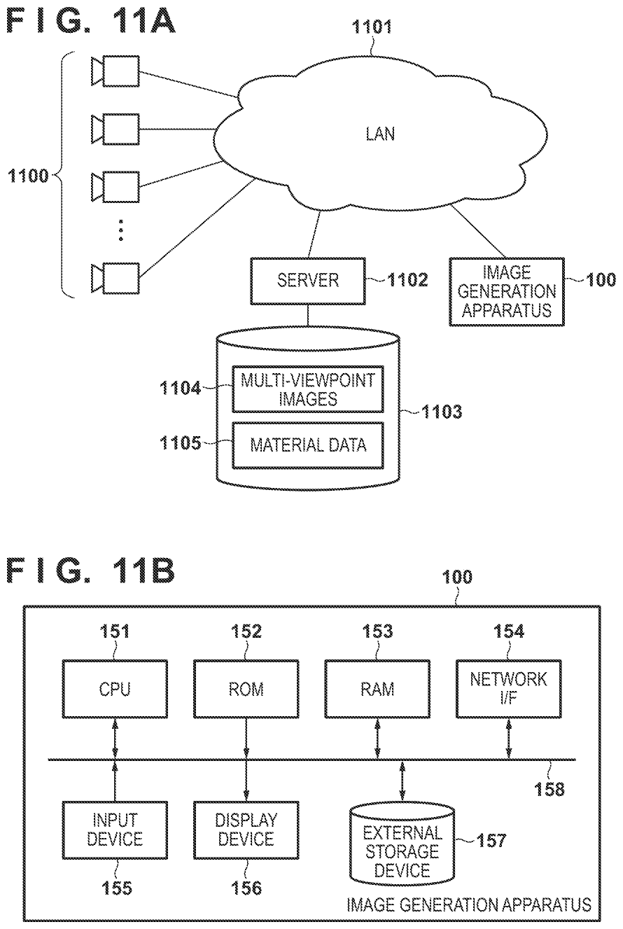

FIG. 11A is a block diagram showing an example of the configuration of a virtual viewpoint image generation system according to the first embodiment. In FIG. 11A, a plurality of cameras 1100 are connected to a local area network (LAN 1101). A server 1102 stores a plurality of images obtained by the cameras 1100 as multi-viewpoint images 1104 in a storage device 1103 via the LAN 1101. The server 1102 generates, from the multi-viewpoint images 1104, material data 1105 (including a three-dimensional object model, the position of the three-dimensional object, a texture, and the like) for generating a virtual viewpoint image, and stores it in the storage device 1103. An image generation apparatus 100 obtains the material data 1105 (if necessary, the multi-viewpoint images 1104) from the server 1102 via the LAN 1101 and generates a virtual viewpoint image.

FIG. 11B is a block diagram showing an example of the hardware configuration of an information processing apparatus used as the image generation apparatus 100. In the image generation apparatus 100, a CPU 151 implements various processes in the image generation apparatus 100 by executing programs stored in a ROM 152 or a RAM 153 serving as a main memory. The ROM 152 is a read-only nonvolatile memory and the RAM 153 is a random-access volatile memory. A network I/F 154 is connected to the LAN 1101 and implements, for example, communication with the server 1102. An input device 155 is a device such as a keyboard or a mouse and accepts an operation input from a user. A display device 156 provides various displays under the control of the CPU 151. An external storage device 157 is formed from a nonvolatile memory such as a hard disk or a silicon disk and stores various data and programs. A bus 158 connects the above-described units and performs data transfer.

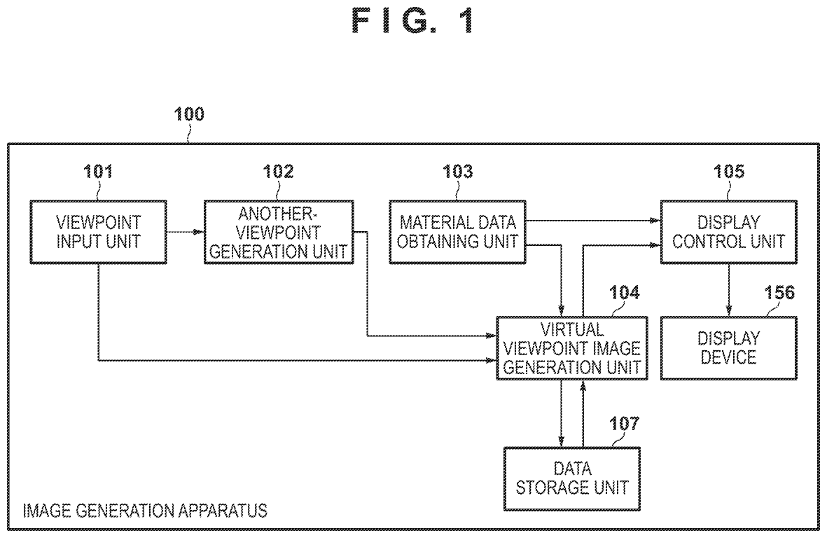

FIG. 1 is a block diagram showing an example of the functional configuration of the image generation apparatus 100 according to the first embodiment. Note that respective units shown in FIG. 1 may be implemented by executing predetermined programs by the CPU 151, implemented by dedicated hardware, or implemented by cooperation between software and hardware.

A viewpoint input unit 101 accepts a user input of a virtual viewpoint for setting a virtual camera. A virtual viewpoint designated by an input accepted by the viewpoint input unit 101 will be called an input viewpoint. A user input for designating an input viewpoint is performed via the input device 155. An another-viewpoint generation unit 102 generates a virtual viewpoint different from the input viewpoint in order to set the position of another virtual camera based on the input viewpoint designated by the user. A virtual viewpoint generated by the another-viewpoint generation unit 102 will be called another viewpoint. A material data obtaining unit 103 obtains, from the server 1102, the material data 1105 for generating a virtual viewpoint image. Based on the input viewpoint from the viewpoint input unit 101 and another viewpoint from the another-viewpoint generation unit 102, a virtual viewpoint image generation unit 104 generates virtual viewpoint images corresponding to the respective virtual viewpoints by using the material data obtained by the material data obtaining unit 103. A display control unit 105 performs control to display, on the display device 156, an image of material data (for example, one image of the multi-viewpoint images 1104) obtained by the material data obtaining unit 103 and a virtual viewpoint image generated by the virtual viewpoint image generation unit 104. A data storage unit 107 stores a virtual viewpoint image generated by the virtual viewpoint image generation unit 104, information of a viewpoint sent from the viewpoint input unit 101 or the another-viewpoint generation unit 102, and the like by using the external storage device 157. Note that the configuration of the image generation apparatus 100 is not limited to one shown in FIG. 1. For example, the viewpoint input unit 101 and the another-viewpoint generation unit 102 may be mounted in an information processing apparatus other than the image generation apparatus 100.

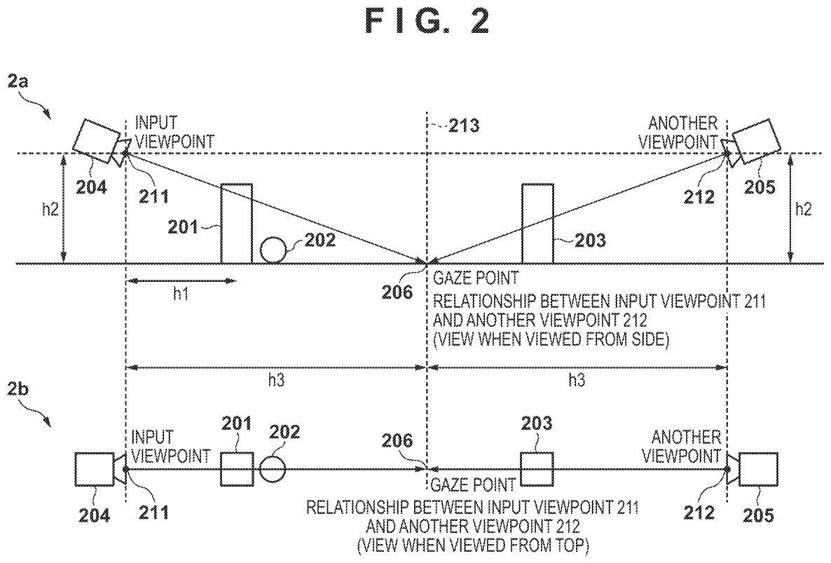

FIG. 2 is a schematic view showing an example of the arrangement of virtual viewpoints (virtual cameras). FIG. 2 shows, for example, the positional relationship between an attacking player, a defensive player, and virtual cameras in a soccer game. In FIG. 2, 2a is a view of the arrangement of the players, a ball, and the virtual cameras when viewed from the side, and 2b is a view of the players, the cameras, and the ball when viewed from the top. In FIG. 2, an attacker 201 controls a ball 202. A defender 203 is a player of an opposing team who tries to prevent an attack from the attacker 201 and faces the attacker 201. A virtual camera 204 is a virtual camera corresponding to an input viewpoint 211 set by a user (for example, a content creator), is arranged behind the attacker 201, and is oriented from the attacker 201 toward the defender 203. The position, direction, orientation, and angle of field of the virtual camera and the like are set as viewpoint information of the input viewpoint 211 (virtual camera 204), but the viewpoint information is not limited to them. For example, the direction of the virtual camera may be set by designating the position of the virtual camera and the position of a gaze point.

A virtual camera 205 is a virtual camera corresponding to another viewpoint 212 set based on the input viewpoint 211 and is arranged to face the virtual camera 204. In the example of FIG. 2, the virtual camera 205 is arranged behind the defender 203, and the line-of-sight direction of the camera is a direction from the defender 203 to the attacker 201. The virtual camera 204 is arranged based on the input viewpoint 211 set by inputting parameters for determining, for example, a camera position and direction manually by the content creator. To the contrary, the other viewpoint 212 (virtual camera 205) is arranged automatically by the another-viewpoint generation unit 102 in response to arranging the input viewpoint 211 (virtual camera 204). A gaze point 206 is a point at which the line of sight of each of the virtual cameras 204 and 205 crosses the ground. In this embodiment, the gaze point of the input viewpoint 211 and that of the other viewpoint 212 are common.

In 2a of FIG. 2, the distance between the input viewpoint 211 and the attacker 201 is h1. The height of each of the input viewpoint 211 and the other viewpoint 212 from the ground is h2. The distance between the gaze point 206 and the position of a perpendicular from each of the input viewpoint 211 and the other viewpoint 212 to the ground is h3. The viewpoint position and line-of-sight direction of the other viewpoint 212 are obtained by rotating those of the input viewpoint 211 by 180° about, as an axis, a perpendicular 213 passing through the gaze point 206.

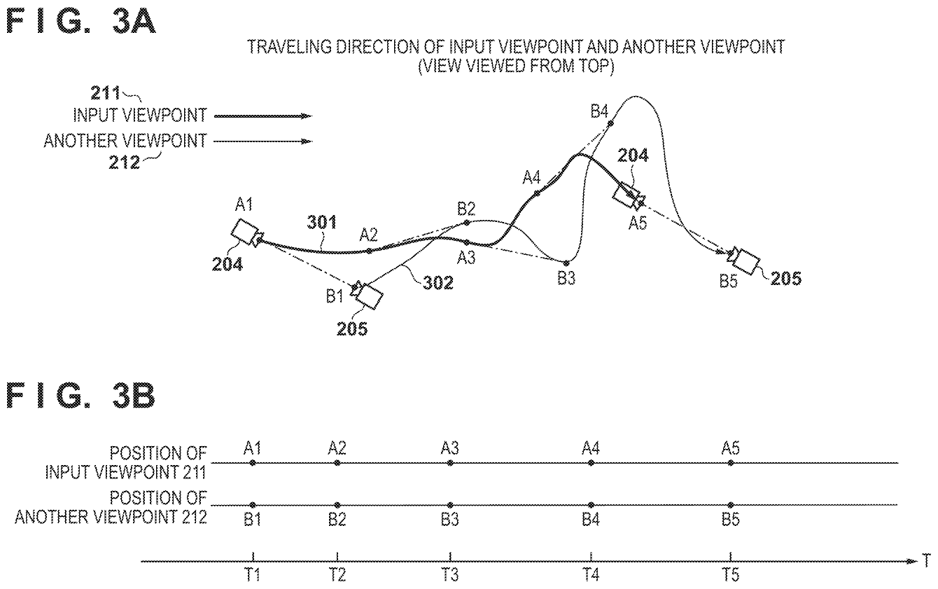

FIG. 3A is a view showing the loci of the input viewpoint 211 and the other viewpoint 212 shown in FIG. 2. The locus (camera path) of the input viewpoint 211 is a curve 301 passing through points A1, A2, A3, A4, and A5, and the locus (camera path) of the other viewpoint 212 is a curve 302 passing through points B1, B2, B3, B4, and B5. FIG. 3B is a view showing the positions of the input viewpoint 211 and other viewpoint 212 at respective timings, in which the abscissa represents time. At timings T1 to T5, the input viewpoint 211 is positioned from A1 to A5 and the other viewpoint 212 is positioned from B1 to B5. For example, A1 and B1 represent the positions of the input viewpoint 211 and other viewpoint 212 at the same timing T1.

In FIG. 3A, the directions of straight lines connecting the points A1 and B1, the points A2 and B2, the points A3 and B3, the points A4 and B4, and the points A5 and B5 represent the line-of-sight directions of the input viewpoint 211 and other viewpoint 212 at the timings T1 to T5. That is, in this embodiment, the lines of sight of the two virtual viewpoints (virtual cameras) are oriented in directions in which they always face each other at each timing. This also applies to the distance between the two virtual viewpoints. The distance between the input viewpoint 211 and the other viewpoint 212 at each timing is set to be always constant.

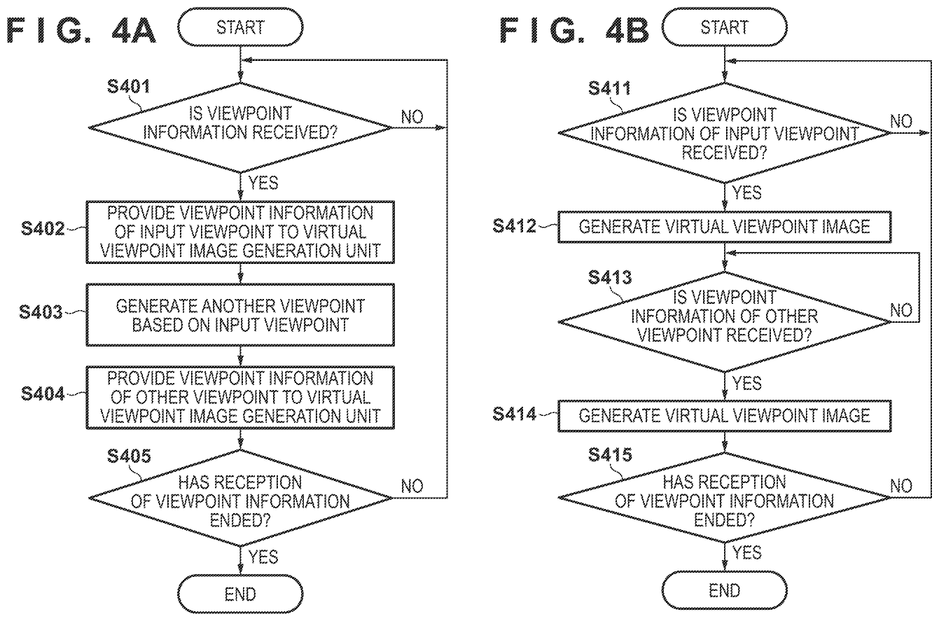

Next, the operation of the another-viewpoint generation unit 102 will be described. FIG. 4A is a flowchart showing processing of obtaining viewpoint information by the viewpoint input unit 101 and the another-viewpoint generation unit 102. In step S401, the viewpoint input unit 101 determines whether the content creator has input viewpoint information of the input viewpoint 211. If the viewpoint input unit 101 determines in step S401 that the content creator has input viewpoint information, the process advances to step S402. In step S402, the viewpoint input unit 101 provides the viewpoint information of the input viewpoint 211 to the another-viewpoint generation unit 102 and the virtual viewpoint image generation unit 104. In step S403, the another-viewpoint generation unit 102 generates another viewpoint based on the viewpoint information of the input viewpoint. For example, as described with reference to FIG. 2, the another-viewpoint generation unit 102 generates the other viewpoint 212 based on the input viewpoint 211 and generates its viewpoint information. In step S404, the another-viewpoint generation unit 102 provides the viewpoint information of the generated other viewpoint to the virtual viewpoint image generation unit 104. In step S405, the another-viewpoint generation unit 102 determines whether reception of the viewpoint information from the viewpoint input unit 101 has ended. If the another-viewpoint generation unit 102 determines that reception of the viewpoint information has ended, the flowchart ends. If the another-viewpoint generation unit 102 determines that the viewpoint information is being received, the process returns to step S401.

By the above-described processing, the another-viewpoint generation unit 102 generates another viewpoint in time series following a viewpoint input in time series from the viewpoint input unit 101. For example, when the input viewpoint 211 that moves so as to draw the curve 301 shown in FIG. 3A is input, the another-viewpoint generation unit 102 generates the other viewpoint 212 so as to draw the curve 302 following the curve 301. The virtual viewpoint image generation unit 104 generates virtual viewpoint images from the viewpoint information from the viewpoint input unit 101 and another viewpoint information from the another-viewpoint generation unit 102.

Next, virtual viewpoint image generation processing by the virtual viewpoint image generation unit 104 will be described. FIG. 4B is a flowchart showing processing of generating a virtual viewpoint image by the virtual viewpoint image generation unit 104. In step S411, the virtual viewpoint image generation unit 104 determines whether it has received viewpoint information of the input viewpoint 211 from the viewpoint input unit 101. If the virtual viewpoint image generation unit 104 determines in step S411 that it has received the viewpoint information, the process advances to step S412. If the virtual viewpoint image generation unit 104 determines that it has not received the viewpoint information, the process returns to step S411. In step S412, the virtual viewpoint image generation unit 104 arranges the virtual camera 204 based on the received viewpoint information and generates a virtual viewpoint image to be captured by the virtual camera 204.

In step S413, the virtual viewpoint image generation unit 104 determines whether it has received viewpoint information of the other viewpoint 212 from the another-viewpoint generation unit 102. If the virtual viewpoint image generation unit 104 determines in step S413 that it has received viewpoint information of the other viewpoint 212, the process advances to step S414. If the virtual viewpoint image generation unit 104 determines that it has not received viewpoint information of the other viewpoint 212, the process returns to step S413. In step S414, the virtual viewpoint image generation unit 104 arranges the virtual camera 205 based on the viewpoint information received in step S413 and generates a virtual viewpoint image to be captured by the virtual camera 205. In step S415, the virtual viewpoint image generation unit 104 determines whether reception of the viewpoint information from each of the viewpoint input unit 101 and another-viewpoint generation unit 102 has ended. If the virtual viewpoint image generation unit 104 determines that reception of the viewpoint information is completed, the process of the flowchart ends. If the virtual viewpoint image generation unit 104 determines that reception of the viewpoint information is not completed, the process returns to step S411.

Although steps S412 and S414, which are processes of generating a virtual viewpoint image, are performed in time series in the flowchart of FIG. 4B, the present invention is not limited to this. A plurality of virtual viewpoint image generation units 104 may be provided in correspondence with a plurality of virtual viewpoints to perform the virtual viewpoint image generation processes in steps S412 and S414 in parallel. Note that a virtual viewpoint image generated in step S412 is an image that can be captured by the virtual camera 204. Similarly, a virtual viewpoint image generated in step S414 is an image that can be captured by the virtual camera 205.

Next, the generation (step S403) of the other viewpoint 212 (virtual camera 205) with respect to the input viewpoint 211 (virtual camera 204) will be further explained with reference to FIGS. 2, 3A, and 3B. In this embodiment, when the content creator designates one input viewpoint 211, the other viewpoint 212 is set based on the input viewpoint 211 according to a predetermined rule. As an example of the predetermined rule, a configuration will be described in this embodiment, in which the common gaze point 206 is used for the input viewpoint 211 and the other viewpoint 212 and the other viewpoint 212 is generated by rotating the input viewpoint 211 by a predetermined angle about, as a rotation axis, the perpendicular 213 passing through the gaze point 206.

The content creator arranges the input viewpoint 211 behind the attacker 201 by the distance h1 and at the height h2 larger than the attacker 201. The line-of-sight direction of the input viewpoint 211 is oriented in a direction toward the defender 203 at the timing T1. In this embodiment, an intersection point of the ground and the line of sight of the input viewpoint 211 serves as the gaze point 206. In contrast, the other viewpoint 212 at the timing T1 is generated by the another-viewpoint generation unit 102 in step S403 of FIG. 4A. In this embodiment, the another-viewpoint generation unit 102 obtains the other viewpoint 212 by rotating the position of the input viewpoint 211 by a predetermined angle (180° in this embodiment) about, as a rotation axis, the perpendicular 213 that passes through the gaze point 206 and is a line perpendicular to the ground. As a result, the other viewpoint 212 is arranged in a three-dimensional range of the height h2 and the distance h3 from the gaze point 206.

Note that the gaze point 206 is set at the ground in this embodiment, but is not limited to this. For example, when the line-of-sight direction of the input viewpoint 211 represented by input line-of-sight information is parallel to the ground, the gaze point can be set at a point at the height h2 on the perpendicular 213 passing through the gaze point 206. The another-viewpoint generation unit 102 generates another viewpoint in accordance with an input viewpoint set in time series so as to maintain the relationship in distance and line-of-sight direction between the input viewpoint and the other viewpoint. Hence, the method of generating the other viewpoint 212 from the input viewpoint 211 is not limited to the above-described one. For example, the gaze point of the input viewpoint 211 and that of the other viewpoint 212 may be set individually.

In the example of FIG. 3A, the curve 301 represents the locus of the input viewpoint 211 upon the lapse of time from the timing T1, and positions of the input viewpoint 211 (positions of the virtual camera 204) at the timings T2, T3, T4, and T5 are A2, A3, A4, and A5, respectively. Similarly, positions of the other viewpoint 212 (positions of the virtual camera 205) at the timings T2, T3, T4, and T5 are B2, B3, B4, and B5 on the curve 302, respectively. The positional relationship between the input viewpoint 211 and the other viewpoint 212 maintains an opposing state at the timing T1, and the input viewpoint 211 and the other viewpoint 212 are arranged at positions symmetrical about the perpendicular 213 passing through the gaze point 206 at each timing. The position of the other viewpoint 212 (position of the virtual camera 205) is automatically arranged based on the input viewpoint 211 set by a user input so as to establish this positional relationship at each of the timings T1 to T5. Needless to say, the position of another viewpoint is not limited to the above-mentioned positional relationship and the number of other viewpoints is not limited to one.

In the first embodiment, the virtual camera 205 is arranged at a position obtained by 180°—rotation about, as an axis, the perpendicular 213 passing through the gaze point 206 based on viewpoint information (for example, the viewpoint position and the line-of-sight direction) of the input viewpoint 211 created by the content creator, but is not limited to this. In FIG. 2, the parameters of the viewpoint height h2, horizontal position h3, and line-of-sight direction that determine the position of the other viewpoint 212 may be changed according to a specific rule. For example, the height of the other viewpoint 212 and the distance from the gaze point 206 may differ from the height and distance of the input viewpoint 211. Also, other viewpoints may be arranged respectively at positions obtained by rotating the input viewpoint 211 by every 120° about the perpendicular 213 as an axis. Another viewpoint may be generated at the same position as the input viewpoint in a different orientation and/or angle of field.

As described above, according to the first embodiment, when generating a virtual viewpoint image, an input viewpoint is set by a user input, and another viewpoint different from the input viewpoint in at least one of the position and direction is set automatically. According to the first embodiment, a plurality of virtual viewpoint images corresponding to a plurality of virtual viewpoints at a common timing can be obtained easily.

### Second Embodiment

In the first embodiment, the configuration has been described, in which another viewpoint (for example, a viewpoint at which the virtual camera 205 is arranged) is set automatically based on an input viewpoint (for example, a viewpoint at which the virtual camera 204 is arranged) set by the user. In the second embodiment, another viewpoint is set automatically using the position of an object. Note that a virtual viewpoint image generation system and the hardware configuration and functional configuration of an image generation apparatus 100 in the second embodiment are the same as those in the first embodiment (FIGS. 11A, 11B, and 1). Note that an another-viewpoint generation unit 102 can receive material data from a material data obtaining unit 103.

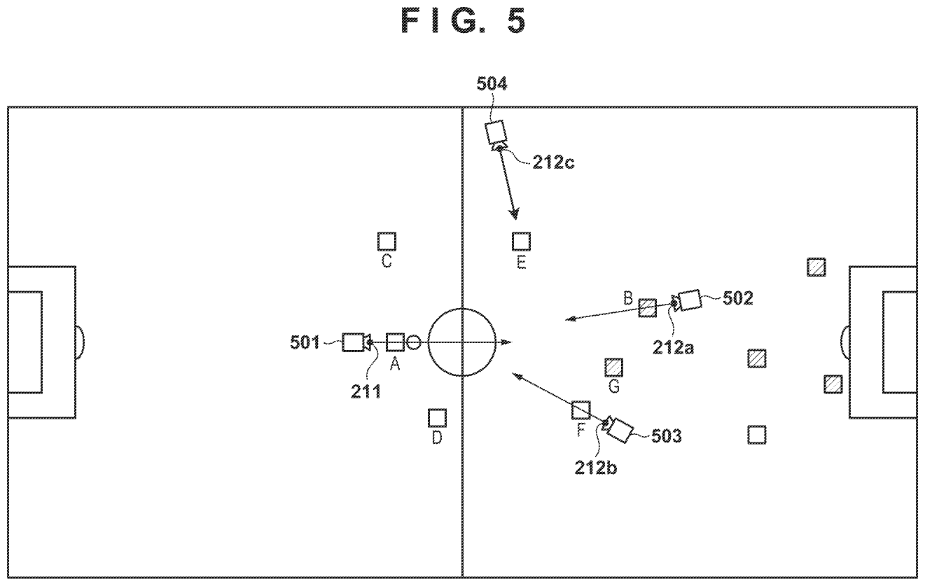

FIG. 5 is a schematic view showing a simulation of a soccer game and is a view showing the arrangement of viewpoints (virtual cameras) when a soccer field is viewed from the top. In FIG. 5, blank-square objects and hatched objects represent soccer players and the presence and absence of hatching represent teams to which they belong. In FIG. 5, a player A keeps a ball. A content creator sets an input viewpoint 211 behind the player A (side opposite to the position of the ball), and a virtual camera 501 based on the input viewpoint 211 is installed. Players B to G in the team of the player A and the opposing team are positioned around the player A. Another viewpoint 212a (virtual camera 502) is arranged behind the player B, another viewpoint 212b (virtual camera 503) is arranged behind the player F, and another viewpoint 212c (virtual camera 504) is arranged at a location where all the players A to G can be looked from the side. Note that the input viewpoint 211 side of the players B and F is called the front, and the opposite side is called the back.

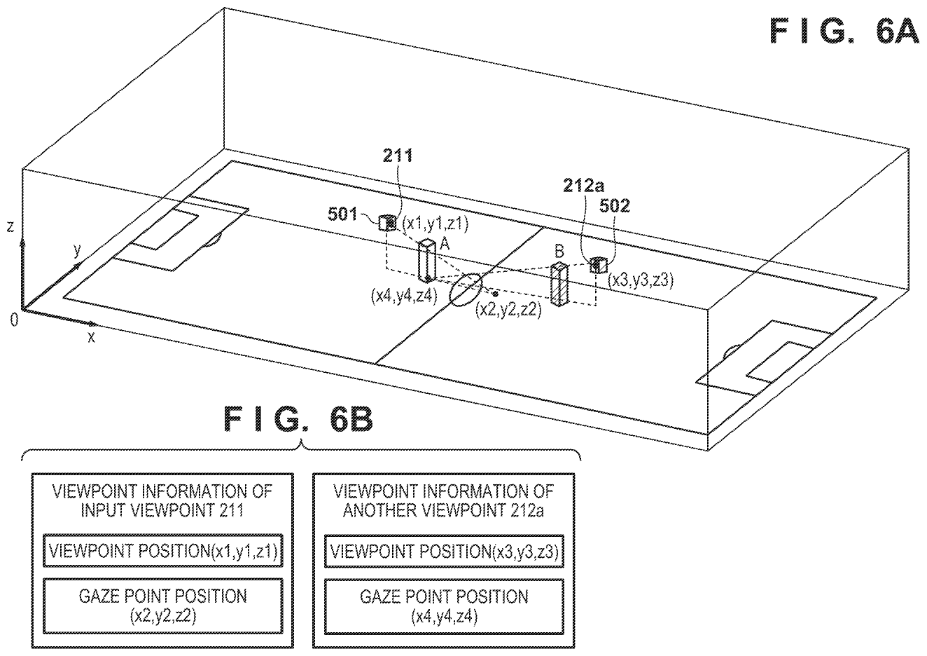

FIG. 6A is a view three-dimensionally showing the soccer field in FIG. 5. In FIG. 6A, one of four corners of the soccer field is defined as the origin of three-dimensional coordinates, the longitudinal direction of the soccer field is defined as the x-axis, the widthwise direction is defined as the y-axis, and the height direction is defined as the z-axis. FIG. 6A shows only the players A and B out of the players shown in FIG. 5, and shows the input viewpoint 211 (virtual camera 501) and the other viewpoint 212a (virtual camera 502) out of the viewpoints (virtual cameras) shown in FIG. 5. FIG. 6B is a view showing pieces of viewpoint information of the input viewpoint 211 and other viewpoint 212a shown in FIG. 6A. The viewpoint information of the input viewpoint 211 includes the coordinates (x1, y1, z1) of the viewpoint position and the coordinates (x2, y2, z2) of the gaze point position. The viewpoint information of the other viewpoint 212a includes the coordinates (x3, y3, z3) of the viewpoint position and the coordinates (x4, y4, z4) of the gaze point position.

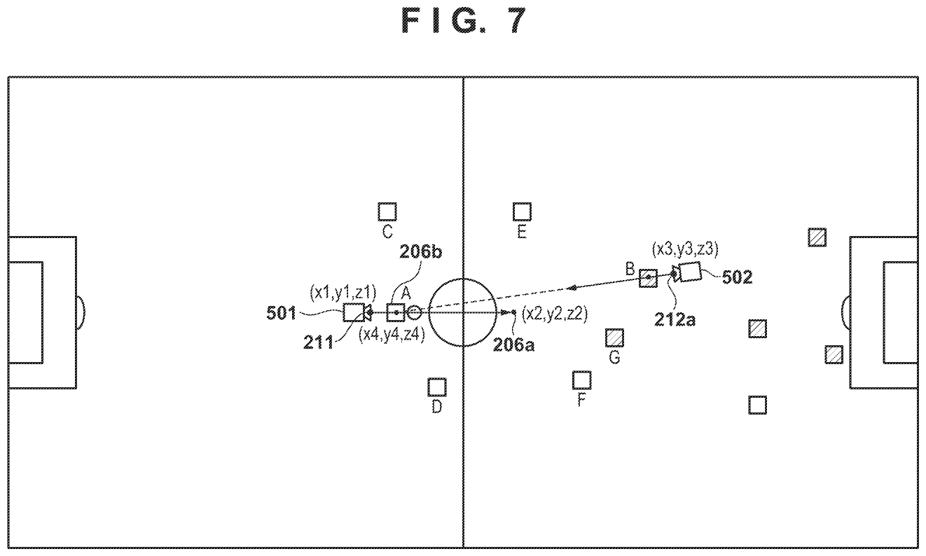

FIG. 7 shows the three-dimensional coordinates (FIG. 6B) of the viewpoint positions and gaze point positions of the input viewpoint 211 (virtual camera 501) and other viewpoint 212a (virtual camera 502) that are plotted in the birds-eye view shown in FIG. 5. The input viewpoint 211 (virtual camera 501) is oriented in a direction in which the player A is connected to the ball, and the other viewpoint 212a (virtual camera 502) is oriented in a direction in which the player B is connected to the player A.

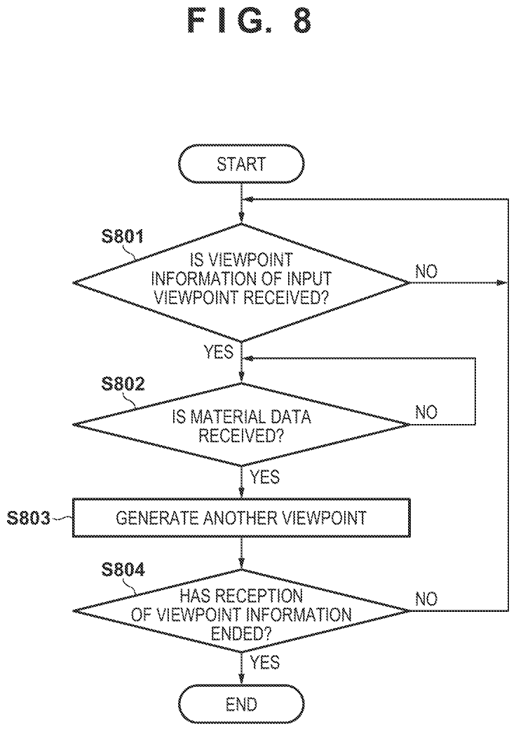

FIG. 8 is a flowchart showing generation processing of the other viewpoint 212a by the another-viewpoint generation unit 102 according to the second embodiment. In step S801, the another-viewpoint generation unit 102 determines whether it has received viewpoint information of the input viewpoint 211 from a viewpoint input unit 101. If the another-viewpoint generation unit 102 determines in step S801 that it has received the viewpoint information, the process advances step S802. If the another-viewpoint generation unit 102 determines that it has not received the viewpoint information, the process repeats step S801. In step S802, the another-viewpoint generation unit 102 determines whether it has obtained the coordinates of the players A to G (coordinates of the objects) included in material data from the material data obtaining unit 103. If the another-viewpoint generation unit 102 determines that it has obtained the material data, the process advances to step S803. If the another-viewpoint generation unit 102 determines that it has not obtained the material data, the process repeats step S802.

In step S803, the another-viewpoint generation unit 102 generates the viewpoint position and gaze point position (another viewpoint) of the virtual camera 502 based on the viewpoint information obtained in step S801 and the material data (coordinates of the objects) obtained in step S802. In step S804, the another-viewpoint generation unit 102 determines whether reception of the viewpoint information from the viewpoint input unit 101 has ended. If the another-viewpoint generation unit 102 determines that reception of the viewpoint information has ended, the flowchart ends. If the another-viewpoint generation unit 102 determines that the viewpoint information is being received, the process returns to step S801.

The generation of another viewpoint in step S803 will be described in detail. As shown in FIG. 7, the input viewpoint 211 set by the content creator is positioned at the coordinates (x1, y1, z1) behind the player A, and the coordinates of the gaze point position of the input viewpoint 211 are (x2, y2, z2). A position at which the line of sight in the line-of-sight direction set for the input viewpoint 211 crosses a plane of a predetermined height (for example, the ground) is defined as a gaze point 206. Alternatively, the content creator may designate a gaze point 206a to set a line-of-sight direction so as to connect the input viewpoint 211 and the gaze point 206. The another-viewpoint generation unit 102 according to this embodiment generates another viewpoint based on the positional relationship between two objects (in this example, the players A and B) included in multi-viewpoint images 1104. In this embodiment, after the thus-generated other viewpoint is determined as an initial viewpoint, the other viewpoint is caused to follow the position of the object (player A) so as to maintain the relationship in position and line-of-sight direction with the other object (player A).

Next, an initial viewpoint determination method will be explained. First, the another-viewpoint generation unit 102 obtains viewpoint information of the input viewpoint 211 including the coordinates (x1, y1, z1) of the viewpoint position and the coordinates (x2, y2, z2) of the gaze point position from the viewpoint input unit 101. Then, the another-viewpoint generation unit 102 obtains the position coordinates (information of the object position in the material data) of each player from the material data obtaining unit 103. For example, the position coordinates of the player A are (xa, ya, za). The value za in the height direction in the position coordinates of the player A can be, for example, the height of the center of the face of the player or the body height. When the body height is used, the body height of each player is registered in advance.

In this embodiment, the other viewpoint 212a (virtual camera 502) is generated behind the player B. The another-viewpoint generation unit 102 determines the gaze point of the other viewpoint 212a based on the position of the player A closest to the input viewpoint 211. In this embodiment, the position of the gaze point on the x-y plane is set as a position (xa, ya) of the player A on the x-y plane, and the position in the z direction is set as a height from the ground. In this example, the coordinates of the gaze point position are set as (x4, y4, z4)=(xa, ya, 0). The another-viewpoint generation unit 102 sets, as the viewpoint position of the other viewpoint 212a, a position spaced apart from the position of the player B by a predetermined distance on a line connecting the position coordinates of the player B and the coordinates (x4, y4, z4) of the gaze point position of the other viewpoint 212a. In FIG. 7, coordinates (x3, y3, z3) are set as the viewpoint position of the other viewpoint 212a (virtual camera 502). The predetermined distance may be a distance set by the user in advance or may be determined by the another-viewpoint generation unit 102 based on the positional relationship (for example, distance) between the players A and B.

After the viewpoint position of the other viewpoint 212a is determined based on the positional relationship between the players A and B and the gaze point position is determined based on the position coordinates of the player A in this manner, the distance between the other viewpoint 212a and the player A and the line-of-sight direction are fixed. That is, after the viewpoint position and gaze point position of the other viewpoint 212a are determined in accordance with the setting of the input viewpoint 211, the distance and direction of the other viewpoint 212a with respect to the gaze point determined from the position coordinates of the player A are fixed. By this setting, even if the position coordinates of the players A and B change over time, the positional relationship between the other viewpoint 212a (virtual camera 502) and the player A is maintained. After the viewpoint information of the other viewpoint 212a is determined in accordance with the input viewpoint 211 (virtual camera 501) and the position coordinates of the players A and B, the viewpoint position and gaze point position of the other viewpoint 212a (virtual camera 502) are determined from the position coordinates of the player A.

Note that the another-viewpoint generation unit 102 needs to specify two objects of the players A and B in order to generate the other viewpoint 212a. Both the players A and B are objects included in a virtual viewpoint image from the input viewpoint 211. For example, an object closest to the input viewpoint 211 is selected as the player A, and the player B can be specified by selecting an object by the user from the virtual viewpoint image of the input viewpoint 211. Note that the user may select an object serving as the player A. Although the distance between the other viewpoint 212a and the player A and the line-of-sight direction are fixed in the above description, the present invention is not limited to this. For example, the processing of determining the other viewpoint 212a based on the positions of the players A and B (the above-described processing of determining an initial viewpoint) may be continued. Alternatively, an object (object corresponding to the player B) used to generate another viewpoint may be selected based on the attribute of the object. For example, a team to which each object belongs may be determined based on the uniform of the object, and an object belonging to the opposing team or the team of the player A may be selected as the player B from objects present in a virtual viewpoint image obtained by the virtual camera 501. A plurality of viewpoints can be set simultaneously by selecting a plurality of objects used to set another viewpoint.

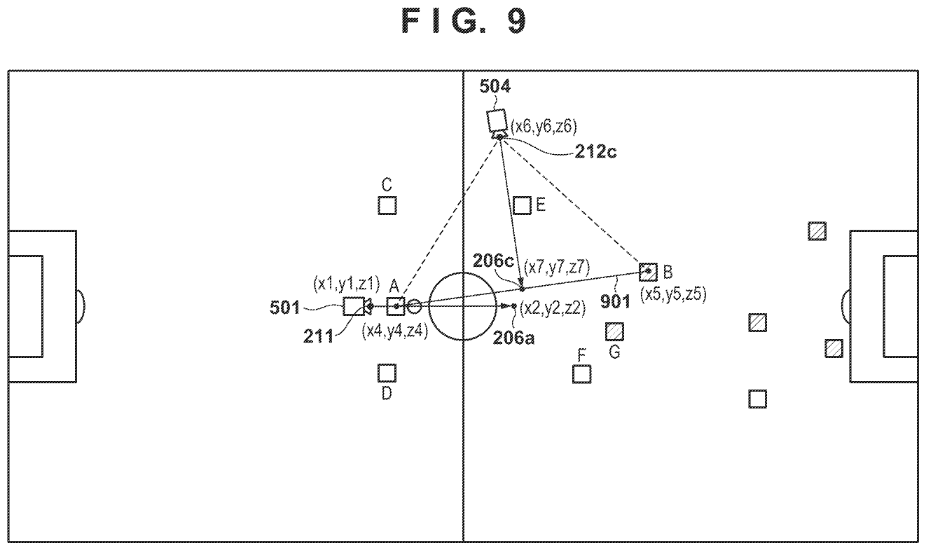

The configuration has been described above, in which another viewpoint is set behind a player near the player A in response to setting the input viewpoint 211 by the content creator. However, the another-viewpoint setting method is not limited to this. As shown in FIG. 9, the other viewpoint 212c may be arranged in the lateral direction of the players A and B to capture both the players A and B in the angle of field, that is, capture both the players A and B in the field of view of the other viewpoint 212c. In FIG. 9, the middle (for example, a midpoint (x7, y7, z7)) of a line segment 901 connecting the position coordinates of the players A and B is set as a gaze point 206c, and the other viewpoint 212c for the virtual camera 504 is set on a line perpendicular to the line segment 901 at the gaze point 206c. A distance from the other viewpoint 212c to the gaze point 206c and an angle of field are set so that both the players A and B fall within the angle of field, and position coordinates (x6, y6, z6) of the other viewpoint 212c are determined. Note that it is also possible to fix an angle of field and set a distance between the other viewpoint 212c and the gaze point 206c so that both the players A and B fall within the angle of field.

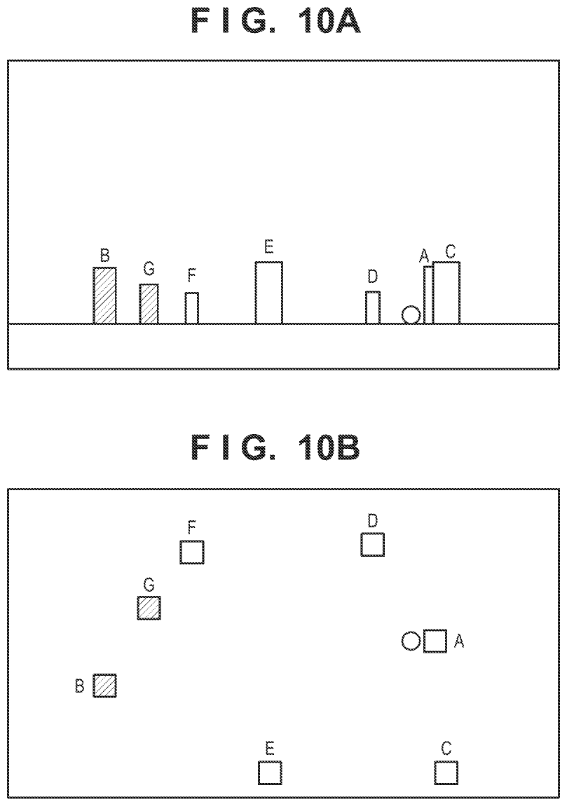

A virtual viewpoint image captured by the virtual camera 504 arranged at the other viewpoint 212c is, for example, an image as shown in FIG. 10A. By setting a large z6 in the position coordinates (x6, y6, z6) of the other viewpoint 212c (virtual camera 504), as shown in FIG. 10B, an image viewed from above the field can be so obtained as to capture players around the player A. Alternatively, the other viewpoint 212c may be rotated by a predetermined angle from the x-y plane about, as an axis, the line segment 901 connecting the positions of the players A and B.

Note that a display control unit 105 displays, on a display device 156, the virtual viewpoint images of an input viewpoint and another viewpoint that are generated by a virtual viewpoint image generation unit 104. The display control unit 105 may simultaneously display a plurality of virtual viewpoint images so that the user can select a virtual viewpoint image he/she wants.

As described above, according to each of the embodiments, another viewpoint is set automatically in accordance with an operation of setting one input viewpoint by the content creator. Since a plurality of virtual viewpoints at the set timing of one virtual viewpoint are obtained in accordance with the operation of setting one virtual viewpoint, a plurality of virtual viewpoints (and virtual viewpoint images) at the same timing can be created easily. Although an input viewpoint is set by the content creator in the description of each of the embodiments, it is not limited to this and may be set by an end user or another person. Alternatively, the image generation apparatus 100 may obtain viewpoint information representing an input viewpoint from the outside and generate viewpoint information representing another viewpoint corresponding to the input viewpoint.

The image generation apparatus 100 may determine whether to set another viewpoint or the number of other viewpoints to be set, in accordance with an input user operation, the number of objects in the shooting target area, the generation timing of an event in the shooting target area, or the like. When an input viewpoint and another viewpoint are set, the image generation apparatus 100 may display both a virtual viewpoint image corresponding to the input viewpoint and a virtual viewpoint image corresponding to the other viewpoint on the display unit, or switch and display them.

Although soccer has been exemplified in the description of each of the embodiments, the present invention is not limited to this. For example, the present invention may be applied to a sport such as rugby, baseball, or skating, or a play performed on a stage. Although a virtual camera is set based on the positional relationship between players in each of the embodiments, the present invention is not limited to this and a virtual camera may be set in consideration of, for example, the position of a referee or grader.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-127794, filed Jul. 4, 2018 which is hereby incorporated by reference herein in its entirety.

What is claimed is:

1. An information processing apparatus comprising:
a setting unit configured to set a first virtual viewpoint regarding generation of a virtual viewpoint image based on multi-viewpoint images obtained from a plurality of cameras; and
a generation unit configured to generate, based on the first virtual viewpoint set by the setting unit, viewpoint information representing a second virtual viewpoint that is different in at least one of a position and direction from the first virtual viewpoint set by the setting unit and corresponds to a timing common to the first virtual viewpoint.

2. The information processing apparatus according to claim 1, wherein the setting unit sets the first virtual viewpoint in time series, and
the generation unit generates the viewpoint information representing the second virtual viewpoint set in time series to maintain a relationship in distance and line-of-sight direction between the first virtual viewpoint and the second virtual viewpoint.

3. The information processing apparatus according to claim 1, wherein the first virtual viewpoint and the second virtual viewpoint have a common gaze point.

4. The information processing apparatus according to claim 3, wherein the viewpoint information representing the second virtual viewpoint is generated by rotating the first virtual viewpoint by a predetermined angle about a perpendicular passing through the gaze point as a rotation axis.

5. The information processing apparatus according to claim 3, wherein a line-of-sight direction of the first virtual viewpoint is determined by designating a viewpoint position of the first virtual viewpoint and a position of the gaze point by a user.

6. The information processing apparatus according to claim 1, further comprising an image generation unit configured to generate a virtual viewpoint image corresponding to the first virtual viewpoint set by the setting unit and a virtual viewpoint image corresponding to the second virtual viewpoint represented by the viewpoint information generated by the generation unit.

7. An information processing apparatus comprising:
a setting unit configured to set a first virtual viewpoint regarding generation of a virtual viewpoint image based on multi-viewpoint images obtained from a plurality of cameras; and
a generation unit configured to generate, based on a position of an object included in the multi-viewpoint images, viewpoint information representing a second virtual viewpoint that is different in at least one of a position and direction from the first virtual viewpoint set by the setting unit and corresponds to a timing common to the first virtual viewpoint.

8. The information processing apparatus according to claim 7, wherein the generation unit generates the viewpoint information representing the second virtual viewpoint determined based on a positional relationship between a first object and a second object included in the multi-viewpoint images.

9. The information processing apparatus according to claim 8, wherein the generation unit determines the second virtual viewpoint based on the positional relationship between the first object and the second object, and then causes the second virtual viewpoint to follow the first object to maintain a relationship in position and line-of-sight direction with the first object.

10. The information processing apparatus according to claim 8, wherein the generation unit generates the viewpoint information to capture the first object and the second object in a field of view of the second virtual viewpoint.

11. The information processing apparatus according to claim 10, wherein a gaze point of the second virtual viewpoint is set at a middle between the first object and the second object.

12. The information processing apparatus according to claim 8, wherein the first object and the second object are objects included in a virtual viewpoint image corresponding to the first virtual viewpoint set by the setting unit, and the first object is an object closest to the first virtual viewpoint.

13. The information processing apparatus according to claim 8, further comprising a designation unit configured to designate the second object based on a user operation.

14. The information processing apparatus according to claim 7, further comprising an unit configured to obtain a position of an object included in the multi-viewpoint images from material data for generating a virtual viewpoint image.

15. The information processing apparatus according claim 7, further comprising an image generation unit configured to generate a virtual viewpoint image corresponding to the first virtual viewpoint set by the setting unit and a virtual viewpoint image corresponding to the second virtual viewpoint represented by the viewpoint information generated by the generation unit.

16. A method of controlling an information processing apparatus, comprising:
setting a first virtual viewpoint regarding generation of a virtual viewpoint image based on multi-viewpoint images obtained from a plurality of cameras; and
generating, based on the set first virtual viewpoint, viewpoint information representing a second virtual viewpoint that is different in at least one of a position and direction from the set first virtual viewpoint and corresponds to a timing common to the first virtual viewpoint.

17. The method according to claim 16, further comprising generating a virtual viewpoint image corresponding to the set first virtual viewpoint and a virtual viewpoint image corresponding to the second virtual viewpoint represented by the generated viewpoint information.

18. A method of controlling an information processing apparatus, comprising:
setting a first virtual viewpoint regarding generation of a virtual viewpoint image based on multi-viewpoint images obtained from a plurality of cameras; and
generating, based on a position of an object included in the multi-viewpoint images, viewpoint information representing a second virtual viewpoint that is different in at least one of a position and direction from the set first virtual viewpoint and corresponds to a timing common to the first virtual viewpoint.

19. The method according to claim 18, further comprising generating a virtual viewpoint image corresponding to the set first virtual viewpoint and a virtual viewpoint image corresponding to the second virtual viewpoint represented by the generated viewpoint information.

20. A non-transitory computer-readable medium storing a program for causing a computer to execute each step of a method of controlling an information processing apparatus, the method comprising:
setting a first virtual viewpoint regarding generation of a virtual viewpoint image based on multi-viewpoint images obtained from a plurality of cameras; and
generating, based on the set first virtual viewpoint, viewpoint information representing a second virtual viewpoint that is different in at least one of a position and direction from the set first virtual viewpoint and corresponds to a timing common to the first virtual viewpoint.

21. A non-transitory computer-readable medium storing a program for causing a computer to execute each step of a method of controlling an information processing apparatus, the method comprising:
setting a first virtual viewpoint regarding generation of a virtual viewpoint image based on multi-viewpoint images obtained from a plurality of cameras; and
generating, based on a position of an object included in the multi-viewpoint images, viewpoint information representing a second virtual viewpoint that is different in at least one of a position and direction from the set first virtual viewpoint and corresponds to a timing common to the first virtual viewpoint.
